(19) United States
(12) Patent Application Publication
(10) Pub. No.: US 2020/0149960 A1
(43) Pub. Date: May 14, 2020

(54) SENSING OF SOLAR ULTRAVIOLET RADIATION BY WEARABLE COLORIMETRY

(71) Applicant: LogicInk Corporation, San Francisco, CA (US)

(72) Inventors: Peter FOLLER, San Franciso, CA (US); Ian FRITZ, San Francisco, CA (US); Carlos OLGUIN, San Francisco, CA (US); Steven WROBEL, Oakland, CA (US); Claire Le MAITRE, San Francisco, CA (US); E. Roon KANG, New York, NY (US); Skylar Jackson Eagle TIBBITS, Boston, MA (US)

(21) Appl. No.: 16/622,793

(22) PCT Filed: Jun. 18, 2018
(86) PCT No.: PCT/US2018/038028

§ 371 Date: Dec. 13, 2019

Related U.S. Application Data
(60) Provisional application No. 62/520,809, filed on Jun. 16, 2017.

(51) Int. Cl. G01J 1/50; C09D 11/50; G01N 21/29; G01J 3/52; G01J 3/50

(52) U.S. Cl. CPC G01J 1/50; C09D 11/50; G01J 3/50; G01J 3/52; G01N 21/293

(57) ABSTRACT

A wearable UV indicator, methods of making and using same. The indicator includes a polymeric film substrate having a first side and a second side, an adhesive disposed on the first side of the substrate, and a readily understood user interface disposed on the second side of the substrate, wherein the user interface comprises a qualitative indicator of instantaneous intensity of solar ultraviolet irradiation and a qualitative indicator of accumulated exposure to solar ultraviolet radiation.

### CROSS REFERENCE TO RELATED APPLICATIONS

This application claims the benefit of U.S. Provisional Application No. 62/520,809, filed Jun. 16, 2017, the entire contents of which are incorporated by reference herein.

### INCORPORATION BY REFERENCE

All patents, patent applications, and publications cited herein are hereby incorporated by reference in their entirety in order to more fully describe the state of the art as known to those skilled therein as of the date of the invention described herein.

### TECHNICAL FIELD

Described herein are wearable indicators of the presence of solar ultraviolet (UV) radiation. In particular, this invention relates to qualitative colorimetric dose-responsive UV indicators that are capable of providing both instantaneous and cumulative dose information to their wearer.

### BACKGROUND

There is a need for simple and readily understood, low-cost, wearable solar combination UVA (320-400 nm) and UVB (290-320 nm) sensors that can inform a user as to both their instantaneous and accumulated UV exposure, without the required use of additional electronic devices. The purpose of such devices is UV radiation exposure awareness education with the view to mitigate sunburn, skin cancer, premature aging, and the like. There exist electronics-free methods of informing a user as to their instantaneous UV exposure, in the form of bracelets or stickers that contain photochromic materials such as “Sunburn Alert” (sunburnalert.com) that only signal the presence of UV radiation. These products lack design, and are generally targeted to the concerned parents. Devices that offer information beyond instantaneous exposure levels are often bulky, being bracelets containing a photodiode and Bluetooth communications to a smart phone app (e.g.: products from Raymio (raymio.com) and Netatmo June (netatmo.com)). There are other electronics-dependent devices in a 2-dimensional sticker format, such as “My UV Patch” (from LaRoche-Posay (www.laroche-posay.co.uk/uv-patch), which uses NFC communications to a smartphone to relay its information to users. Intelligo Technologies AB (Sweden) offers a wearable UV sensor based on a license of issued U.S. Pat. No. 9,097,588 (Mills, et. al) from the University of Strathclyde, which is a 2-dimensional sticker that senses instantaneous and cumulative UV on the basis of qualitative colorimetric chemistry different from that of the present invention. The principle difference is the chemistry is printed from a 1-butanol solution of polyvinylbutyral, non-aqueous chemistry that leads to volatile organic compound (VOC) emissions issues in printing.

### SUMMARY

The present application discloses an electronics-free wearable applique, a wearable for the skin (incorporating artwork similar to that of a temporary tattoo; however, the artwork is applied to a substrate film thus rendering the form factor that of a sticker or temporary tattoo depending on the method of application). The device informs users of both their instantaneous and accumulated solar UV exposure. The qualitative guidance on one's UV exposure provided by the device can be read with the unaided eye, though more specific information can be provided by reading its color changes with the aid of the camera of a smartphone via a companion application.

A colorimetric UV sensor is provided in the form of a film applique to skin, clothing, or other locations of a user's choosing, that through color change, indicates both the present intensity of UV and one's cumulative exposure to UV. The purpose of the device is to provide a qualitative basis for decision making on controlling one's UV exposure through either application or re-application of sunscreen, covering exposed skin, or removing oneself from the sun entirely. The device can also provide a basis for the decision to remain exposed to UV, in order to facilitate sufficient Vitamin D production or to facilitate safer tanning.

The device sandwiches two types of UV-sensitive printed artwork between a polymeric substrate film and a polymeric UV-transmissive superstrate film, thus fully isolating the chemistry of the inks used from the skin of the wearer. One type of UV-sensitive ink becomes colored and grows more intensely colored in the presence of UV. This reaction is fast and reversible, such that the color intensity provides a guide to the present intensity of UV. The second type of UV sensitive ink changes from one color space to another with the accumulation of chemical change produced by exposure to UV. The second type of UV sensitive ink changes irreversibly and, with a ladder of formulations corresponding to thresholds of accumulated UV exposure, gives the wearer a guide to whether it is wise to remain exposed to the sun. The side of the substrate obverse to the artwork carries an adhesive designed for use on skin protected by a release film that is discarded upon application of the device to the skin.

In accordance with one aspect, the present application is directed to a wearable UV indicator. The wearable UV indicator includes a polymeric film substrate having a first side and a second side, an adhesive disposed on the first side of the substrate, and a readily understood user interface disposed on the second side of the substrate. The user interface includes a qualitative indicator of instantaneous intensity of solar ultraviolet irradiation and a qualitative indicator of accumulated exposure to solar ultraviolet radiation.

A method of monitoring UV exposure is also disclosed. In accordance with one aspect, the method includes applying the wearable UV indicator disclosed herein to a user's skin or clothing.

In accordance with one aspect, a method of making a wearable UV indicator is disclosed. The method includes applying an adhesive to a first side of a substrate, applying a first colorimetric sensing system to a second side of the substrate, and applying a second colorimetric sensing system to the second side of the substrate. Each of the first and second sensing systems is an aqueous based system. The first sensor system comprises a reversible photochromic dye that provides an indication of instantaneous UV intensity and the second sensor system comprises a photo-acid generator and a pH sensitive indicator dye that provides an indication of cumulative UV exposure.

### BRIEF DESCRIPTION OF THE DRAWINGS

FIG. 1 is a representative design of a wearable sensor in accordance with one aspect of the present invention;

FIG. 2 shows an exploded view of a wearable sensor in accordance with one aspect showing the construction of the sensor;

FIG. 3 provides a representative design of a wearable sensor in accordance with another aspect of the present invention;

FIG. 4 provides a representative design of a wearable sensor in accordance with one aspect of the present invention wherein the sensor includes reference colors;

FIG. 5 illustrates an example of a packaging envelope and instructions in accordance with one aspect of the present application;

FIG. 6 provides sample instructions for applying the device in accordance with one aspect of the present application; and

FIGS. 7 -21 provide alternate designs for the wearable sensor in accordance with other aspects of the present invention.

### DETAILED DESCRIPTION

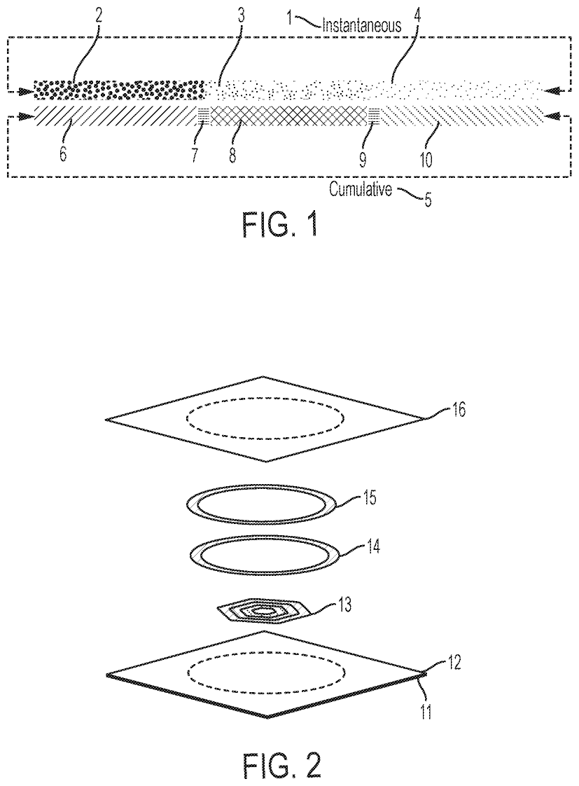

The invention is described with reference to FIG. 1, which is presented for the purpose of illustration only and is not intended to be limiting. It is understood that the user interface presented by the artwork is arbitrary, and that there are many possible designs for artwork to intuitively show relative value by which to convey to the user qualitative information on his or her exposure to UV radiation. For instance, the artwork may show color change taking place progressively along a linear strip, or progressively around a circle, or through the progressive color change of an array of bars of progressively greater height. Of course, there are many further possibilities.

### General Explanation of FIG. 1

The applique is meant to convey increasing solar UV intensity as its Group 1 segments sequentially activate. The applique also conveys increasing accumulated solar UV exposure as its Group 5 segments also activate and change color sequentially. The function of each segment is further described below. As used herein, “UV intensity” means the strength of the UV radiation at a given point in time. As used herein “UV exposure” or “accumulated exposure” means the aggregate exposure of the applique to UV radiation over time. Accumulated exposure can be correlated to provide information in terms of Standard Erythemal Doses (SEDs) of solar UV radiation, one SED being 100 J/m² of UV exposure. Note that while the invention is discussed with respect to solar UV exposure, the UV exposure could be from any UV source.

### The Chemistries Used

Both Group 1 and Group 2 segments use colorimetric sensors to indicate UV intensity or accumulation. In accordance with certain embodiments, the colorimetric sensing chemistries selected are applied as waterborne inks. This is considered a major advantage versus prior art in that commercial printing facilities have become tightly regulated as to volatile organics (VOCs) that can be emitted from their processes. The chemistries of this invention may be printed by screen and flexographic methods, and, in the case of the gradient printing, discussed below, by stencil or ink-jet methods.

### Instantaneous UV Sensing

The instantaneous chemistry is based on reversible photochromic dyes. In the presence of solar UV, the photochromic pigment changes from a first, e.g., colorless state to second, e.g., pink to purple, though any number of colors (blue, red, green, yellow, orange) or color values could be used. In the reversible process, fade-back to clear is a thermally driven process and is typically slower than UV activation. Thus, the intensity of the color fluctuates in proportion to UV and only saturates when as many photochromic molecules as possible are activated, as controlled by the intensity of the UV and ambient temperature.

Exemplary photochromic dyes can be selected from, among others, from such families as spiropyrans, spirooxazines, naphthopyrans, indenonapthopyrans, and diarylethenes. In order to maximize rate of change, advantageously such dyes are pigmentized into particles based on soft (rather than rigid) chemistries. By pigmentization it is meant rather than using the dyes in a soluble form, incorporating them chemically or physically into particulate pigment which is in turn dispersed into the ink formulation. In so doing, the chemical matrix immediately surrounding the dye molecules may be chosen to be flexible (rather than rigid) and with a maximum of void volume. Both flexibility and void volume facilitate the spatial conformational change associated with the change in color state of a photochromic molecule, and thus allow greater rates of color change. Such a pigmentized material (denoted Photochromic MC Pigment #12) is available as a commercial product from New Prismatic Enterprise Co. Ltd. (Taiwan). This pigment is extremely fast to activate and fade, having an estimated T_{1/2} of activation of 1-3 seconds which are entirely acceptable in accordance with certain aspects of the present application.

In the above pigment, we understand a highly active and readily reversible spirooxazine photochromic dye is used in the range of 1-10 wt. %, within a soft matrix. The soft matrix comprises 1-10 wt. % melamine-formaldehyde resin and 80-90 wt. % trioctanoin, the combination of which results in an extraordinarily soft and flexible matrix.

The implementation of this chemistry, as shown in FIG. 1, is more fully described below:

### Group 1: Instantaneous Readouts 2, 3, and 4

To create a colorimetric indicator of the intensity of solar UV, the Segments 2, 3, and 4 are formulated using the photochromic pigment and a UV absorbent in a ladder of photochromic concentrations and UV absorbent. (For example, 5-20% and 0-10% wt % respectively with ratios between the two typically falling within 1:1, 2.5:1, and only photochromic pigment for segments 2, 3, and 4 respectively) such that activation of the photochromic pigment to a colored state is achieved only with exposure to higher UV intensity for each sequential segment. The UV absorbent can be mixed with the photochromic pigment or can be applied as a layer over the photochromic pigment. The UV absorbent can be organic (e.g., avobenzone, octyl methoxycinnamate, homosalate, octacrylene, oxybenzone, octinoxate) or inorganic, (e.g., zinc oxide, titanium oxide). In one embodiment, the UV absorbent is titania. Both the photochromic pigment and UV absorbent are typically included in a carrier. In accordance with some aspects, the carrier can be a water soluble carrier that allows the pigment to be applied, e.g., printed, screened, sprayed, etc., using VOC-restricted printing operations. Exemplary carriers include water soluble polymers, such as carboxymethyl cellulose (CMC), hydroxyethyl cellulose (HEC), methyl cellulose, guar gum, locust bean gum, water base extender.

Segment 2, using no incorporation of UV absorbing titania, achieves its full coloration at a relatively low UV intensity. With the incorporation of a judiciously selected titania concentration atop or within, in Segment 3 a higher intensity of UV is required to achieve full coloration which will be, by simple visual comparison, a more intense color than that developed by Segment 2. In Segment 4, formulated with a higher level of titania atop or within, an even higher level of UV is required to achieve full coloration. Thus, the device is set up as a ladder of segments, which, if all segments become fully activated to their most intense color indicate the user's need for caution with respect to solar UV exposure. The ladder thus qualitatively correlated to the present intensity of solar UV.

### Cumulative UV Sensing

The general principle used is that UV exposure acts upon a photo-acid generator (PAG), such as certain chlorinated hydrocarbons, iodonium salts, or sulphonium salts e.g., triphenylsulfonium triflate, triarylsulfonium hexafluorophosphate, diphenyliodonium nitrate, diphenyliodonium chloride, diphenyliodonium triflate, diphenyliodonium iodide to irreversibly produce hydrogen ion, which, in turn, acts upon a pH indicator dye (e.g., phenol red, methyl red, methyl orange, bromophenol blue, bromothymol blue, thymol blue) to change its color in accordance with the amount of UV exposure. The photo-acid generator typically is present in concentrations between about 0.1-1.5% wt %, more particularly from about 0.2-0.8% and the pH indicator dye typically is present in concentrations between about 0.1-1.5% wt % more particularly from about 0.4-1.0%. Optional anti-oxidants (e.g., pentaerythritol tetrakis(3,5-di-tert-butyl-4-hydroxyhydrocinnamate), tris(2,4-di-tert-butylphenyl) phosphite, didodecyl 3,3′-thiodipropionate, as available from BASF AG) can be included to improve ink stability. Anti-oxidants typically may be included in the amounts of about 0.1-1.0% wt %, more particularly about 0.1-0.5%.

The choice of pH sensitive indicator dyes and the use of under-prints, which are base layers of color printed underneath the main design, allows for aesthetically appealing high contrast color changes. The composition of the inks can be selected to allow for aesthetic appeal, sensitivity to UV radiation, and mass production. The addition of a base (e.g., sodium hydroxide, potassium hydroxide, calcium hydroxide, sodium bicarbonate, sodium carbonate) to the ink allows a delay in UV response by shifting the pH further from the indicator's transition point, allowing for calibration of the device to UV dosages for a minimal erythemal dose (MED) for different skin types. The use of water-soluble combinations of dye, photo-acid, antioxidant, and base allows for high volume printing in modern VOC-restricted printing operations.

The implementation of this chemistry, as shown in FIG. 1, is more fully described below:

### Group 5: Cumulative Readouts and SED Markers 6, 7, 8, 9, and 10

Cumulative UV exposure is sensed through a pH change produced by the irreversible action of UV upon the a photo-acid generator (such as diphenyliodonium chloride in the present example). The hydrogen ion generated serves to change the color of the best mode pH indicator dye (in this example, bromophenol blue). Optionally, the change can be retarded by a calibrated concentration of base (for example, sodium hydroxide) either directly within the ink, or overlaid by a second print atop the ink and allowed to diffuse in. With this method, color change can be set to occur only after a calibrated amount of solar UV (1 SED, for instance) has been absorbed, this being a product of the release of the hydrogen ion from the PAG after exposure to UV and reaching a change in the pH indicator at the calibrated UV exposure.

Segment 6 is calibrated such that, for example, color change occurs after exposure to two Standard Erythemal Doses (SEDs) of solar UV radiation, one SED being 100 J/m² of UV exposure. SED Indicator 7, a fixed tint dye selected from photostable commercially available inks that has been printed between Segments 6 and 8, or optionally on top of a small overlapping portion at the interface of them, indicates to the user with Skin Type 1 that they have reached the level of UV exposure sufficient to begin causing erythema. Segment 8 is calibrated such that, for example, color change occurs after exposure to four SEDs of UV radiation (in this case both Segments 6 and 8 are now activated). SED Indicator 9 indicates to the user with Skin Type 2 that they have reached the level of UV exposure sufficient to begin causing erythema. Segment 10 is calibrated such that, for example, color change occurs after exposure to six SEDs of UV radiation (in this case all segments are now activated).

As a further non-limiting example, the three cumulative chemistry segments may be calibrated to fully change at other thresholds, say two SEDs, three SEDs, and seven SEDs. Alternatively, the indicators can be calibrated to show different SED exposure levels for a specific skin type.

### General Construction of the Device

In accordance with one embodiment, the device comprises a two-fold laminate wherein the inks are “sandwiched” between two polymers, as shown in FIG. 2. The polymers may be silicone, plastic, or elastomer based e.g., polydimethylsiloxane, polyethylene terephthalate, polyurethane, thermoplastic elastomers. A particularly useful polymer is a transluscent thermoplastic polyurethane (TPU) that has a low modulus and therefore conforms very well to the skin, providing comfort and ease of wear, even for multiple days while appearing matte and subtle on the skin. The inks are printed onto the polymer substrate, for example, using standard VOC-limiting methods, after which a second polymer superstrate (typically similar in specifications to the substrate and also TPU) is cold laminated through a roller to the substrate by use of an adhesive on the back of the superstrate.

### General Explanation of FIG. 2

The applique in this example is comprised of 6 layers. From bottom up, there is a pressure sensitive adhesive made of rubber, silicones, or acrylates 11 attached to a printable substrate 12. The adhesive layer can be protected before application in use by a peel-able carrier film (not shown) which easily releases from the adhesive e.g., siliconized paper, polyethylene terephthalate, polycarbonate. If the device is manufactured to be worn on skin this adhesive is medically graded. “Sandwiched” between the superstrate and the substrate are three inks 13-15 applied in any arbitrary design (the design shown is intentionally different from the design in FIG. 1 and presented for the purpose of illustration only and is not intended to be limiting). Note: more or fewer layers can be used to achieve or enhance the function and performance of the instantaneous and cumulative UV sensing layers described herein. Lastly, the superstrate 16 acts as a cover material that seals and protects the artwork from damage via water or abrasion.

1. Film Substrate 12

In accordance with one embodiment of this invention, polydimethyl siloxane (PDMS) and thermoplastic polyurethane (TPU) were selected as the candidate substrate films, 12, on the basis of their extreme flexibility and, in the case of PDMS, its gas permeability, which is beneficial to achieving a comfortable feeling when applied to skin for long periods of time. The substrate film thickness typically is in the range of about 1-6 thousandths of an inch, more particularly about 3-5 thousandths of an inch. The surfaces may be textured by calendering, by coatings, or otherwise treated to reduce gloss, which is believed to be an undesirable feature of such appliques.

Through each of the steps of its processing, the substrate film 12 is to be adhered with a conventional adhesive to a peel-able low cost disposable carrier film such as polyethylene terephthalate (PET) siliconized paper, or, more advantageously, a UV impermeable carrier film such as polycarbonate (PC). Such a carrier film is desired for protection of the substrate, ease of removability after printing has occurred and enough rigidity in order to keep the film secure during the printing process in either sheet format or in web-based (roll-to-roll) printing operations.

2. Adhesives on the Obverse Side of the Substrate 11

An adhesive 11 is applied to the obverse side of the substrate film and is used to adhere the applique optionally either to skin (in which case a medically graded adhesive is used), clothing, or articles carried by the end user. A safe and effective pressure-sensitive adhesive can be selected from either commercial rubber-based, acrylic-based, or commercial silicone-based chemistries. Examples of useful adhesives are available from Adhesives Research, Inc. or Lohmann, Inc. respectively.

3. Printing the Substrate with the Instantaneous Chemistry 13

Prior to printing, an air plasma or corona pretreatment may optionally be used to enhance the wetting and adhesion of the inks to the substrate polymer.

As an example, the ink used for the instantaneous chemistry 13 comprises 3-8 wt. % aqueous carboxymethylcellulose (CMC) base (CMC powder as available from CK Products) and the pigmentized spirooxazine dye discussed above and printed in such an amount as determined by concentration and thickness (e.g., 5-20% wt %) that it activates progressively from clear to pink to a progressively darker purple. Color accumulation may optionally be retarded with the use of a UV absorber as described below. In accordance with certain aspects, a very fine (5-25 nm) amorphous non-photocatalytic form of titania (titanium dioxide), as available from US Research Nanomaterials, Inc. can be used. The titania or other UV absorber may be incorporated into the bulk of the ink (e.g., 0-10% wt %) or applied atop of it in a subsequent print (e.g., 0.1-2 thousandths of an inch, 0-10% wt %). A small particle size of titania (e.g., 5-25 nm) can be chosen so as to not scatter light. If there is a sufficient degree of light scattering, the color of the fully activated ink will appear increasingly pastel, which is regarded as undesirable. Furthermore, small particle size allows for improved suspension of the titania, which improves color consistency and absorption.

After printing of any given layer, an ambient air or a thermally or infrared enhanced drying step is anticipated prior to subsequent printing or the lamination of the superstrate.

### Optional Over-Prints of UV Absorber Atop the Instantaneous Ink

If the UV absorber is optionally used as an over-print, it can be either inorganic (e.g., zinc oxide, titanium oxide) or organic (e.g., avobenzone, octyl methoxycinnamate, homosalate, octacrylene, oxybenzone, octinoxate). In accordance with certain aspects, an insoluble material, such as titania or zinc oxide, is used for the UV absorber as it is meant to reside atop the underlying print of the photochromic.

4. Printing the Substrate with the Cumulative Chemistry 14 and 15

Prior to printing, an air plasma or corona pretreatment may optionally be used to enhance the wetting and adhesion of the inks to the substrate polymer.

Under-prints 14 may be used to enhance either the contrast between or the brightness of the colors of the active inks. Such under-prints may be either white to increase color brightness or colored to enhance the contrast of the initial and activated colors. Such under-prints may also be printed in a gradient to increase color brightness or enhance contrast. The efficacy of these under-prints is determined by the concentration of their active pigments or dyes and the thicknesses applied.

As an example, the ink used for the cumulative chemistry 15 comprises a commercial water soluble pH indicator dye selected to change from a dark blue in the region of pH 4.6 to a bright yellow in the region of pH 3 (e.g., bromophenol blue, as available from Sigma-Aldrich, typically in the amount of 0-1.0% wt. %), photo-acid generator (e.g., diphenyliodonium chloride from Sigma-Aldrich, typically in the amount of about 0.2-0.8 wt. %), and matrix (carboxymethylcellulose from, CK Products, typically in the amount of 3-8 wt. % in water). To delay color change until an arbitrary amount of UV has been absorbed, base is used (for example, sodium hydroxide, as available from Sigma-Aldrich, in amounts calibrated to SEDs of solar UV exposure). Optionally, stabilizers, such as antioxidants (e.g., Pentaerythritol tetrakis(3,5-di-tert-butyl-4-hydroxyhydrocinnamate), tris (2 4-di-tert-butylphenyl) phosphite, didodecyl 3 3′-thiodipropionate, (typically in amounts of about 0.1-0.5% wt %)) may be added to increase shelf life of the ink used due to the reactivity of the photo-acid.

An under-print layer 14 of rubine (a commercial water-based ink as available from Jacquard Products) enhances the color contrast of the bromophenol blue pH indicator dye's color change, producing a bright red/pink final state that is well-distinguished from the device's purple initial state.

### Optional Over Print of Base Atop the Cumulative Ink

In order to neutralize the hydrogen ion produced by the action of UV on the photo-acid and thereby delay the color change of the indicator dye, base may be printing over the cumulative ink formulation. The base may optionally be chosen from inorganic materials such as alkali metal and alkaline earth hydroxides or carbonates such as sodium hydroxide, sodium bicarbonate, sodium carbonate, or calcium hydroxide, but alternatively may be chosen from organic bases such as simple hydrocarbon-based mono- or di-amines or alkanolamines chosen for adequate aqueous solubility such as ethylamine, ethylene diamines, and ethanolamine (pH between 8-11). The amount of base added can be calibrated to the amount of delay desired, i.e., the amount of UV to be absorbed prior to the onset of color change. Thus, with the methods of the present invention, color change can be advantageously calibrated to multiples of SEDs and from there be correlated to the six Fitzpatrick skin types. One SED being 100 J/m² of UV exposure, the amount of base printed over the cumulative ink can be changed in a way such that the pH drops below the indicator's threshold after a multiple of an SED is reach, which translates to a specific Fitzpatrick skin type. Calibration to Fitzpatrick skin types thus will allow users to make personalized decisions as to their sun exposure.

### The Option of Gradient Prints of the Base

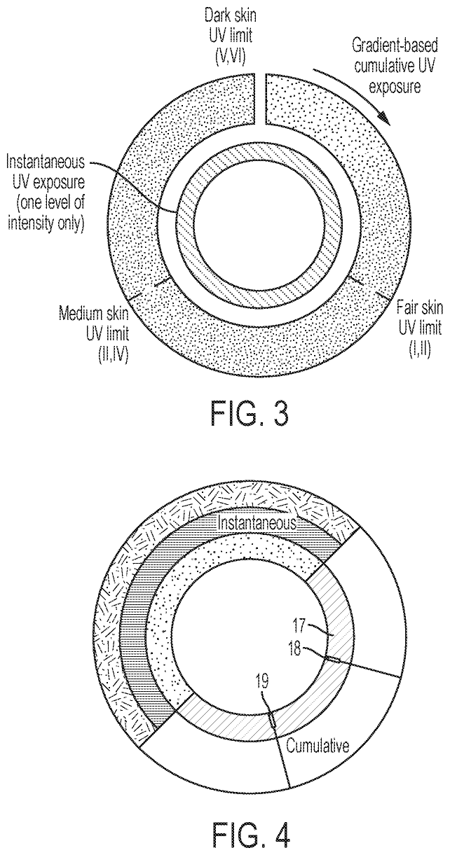

An option is to design artwork to print a gradient of base to set up a progressive growth in coloration (for instance, along a linear or circular strip of artwork) in proportion to the amount of UV irradiation received. Thus, a moving zone of color change is created that, for instance, advances linearly along the artwork as UV accumulation increases. A non-limiting example is shown for illustration purposes in FIG. 3.

To create the gradient described above, 1) base (e.g. sodium hydroxide) is printed in a gradient of concentration (pH between 8-11) over the cumulative chemistry dye layer, and 2) the base diffuses throughout the underlying print of the cumulative chemistry. Alternatively, base can be printed in a gradient as an under-print, and the cumulative chemistry dye layer can be printed atop it. Alternatively, gradients of both the cumulative chemistry dye layer and the base layer can be printed atop each other. For this, it is advantageous that both prints use water-soluble chemistry. Ink jet or stencil printing techniques may be used for the purposes of deposition of the gradient chemistry.

5. Assembly of the Laminate with Superstrate 16

Both prints of UV-sensitive chemistry lie internal to the laminate of substrate and superstrate materials, thus “sandwiching” all chemistry. As substrate to the disclosed devices, commercial polymers available in films may be used such as polydimethylsiloxane (PDMS) available from Bluestar, Gel-Pak, Wacker, or Dow Corning, and thermoplastic polyurethane (TPU), as available from American Polyfilm or Huntsman, or thermoplastic elastomer (TPE) as available from Gel-Pak or PolyOne, may be used. Use of such barrier materials both isolates the skin of an end user from the various inks used in the artwork and protects the artwork from water and abrasion during wear. A commercial polymer film superstrate 16 is used to seal in and isolate the artwork from both skin and the external environment, isolating the artwork from water being a crucial function. The superstrate material may be a self-adhesive or adhesive coated commercial film in the thickness range of about 2-7 thousandths of an inch, more particularly between about 2-3 thousandths of an inch (both PDMS and, with a time at temperature and pressure step, TPU have such properties), a drawdown of one of the aforementioned polymers applied from solution, or a spray coating of one of the aforementioned polymers applied from solution.

Optionally, in the case of the use of a second commercial film as superstrate, portions of the necessary artwork may be applied to both the substrate and the superstrate, and these could subsequently be registered in the assembly of the laminated finished product. The superstrate will also be adhered to a similar protective covering film regardless of the method by which the superstrate is applied over the artwork.

In accordance with certain aspects, the superstrate is wettable by commercial sunscreen emulsions, but does not allow permeation or surface chemical or physical absorption of the active UV blocking ingredients of commercial sunscreens. This is so that the actives in commercial sunscreens may be wiped or washed away mimicking the loss of sunscreen by skin during the course of outdoor activities. It is desired that the application of sunscreen over the applique attenuates color change, but is vulnerable to loss (as is skin), and that the applique will show renewed attenuation upon reapplication.

For the above to best occur, the superstrate film, be it olefin polymer, polyrurethane, polydimethylsiloxane, polyethylene terephthalate, or the like may be advantageously treated with an oleophobic coating. Oleophobic coatings commonly also have hydrophobic properties and have terminal fluorinated or perfluorinated functionality pendant to a hydrocarbon chain of arbitrary length and are applied from organic solvent solution. They may or may not have reactive functionality to bind them to the materials coated. In the case of binding functionality, silane functionality is common, though this may require plasma or corona pretreatment to be effective. Such coatings, despite their hydrophobic and oleophobic properties are wettable by sunscreen emulsions, since emulsions are, by their nature, a stabilized mixture hydrophilic and hydrophobic substances; however, such coatings do moderate adherence and permeation as desired.

### Optional Use of Reference Colors or Other Fixed Tint Markings 17, 18, and 19

Optionally, fixed tint reference colors printed from conventional inks may be incorporated into the artwork as shown in FIG. 4, where labeled elements are as previously described. These, for instance, could be the initial color of the cumulative sensor or the final color 17 it assumes under maximum UV exposure. Such reference colors could be of use in either unassisted visual inspection or for reference by a smartphone camera app. The artwork may or may not also incorporate fixed tint markings 18 and 19 along gradient prints, if any, which would be indicative of the zone of color change crossing a multiple of SED exposure and/or threshold levels for various skin types.

As described herein, colors are read by the user or by an electronic device, such as a smartphone camera. Advantageously the approach invented allows reading of information by relative changes in color as opposed to absolute change. The human eye is well-adapted to detecting and interpreting relative changes among colors, and it simplifies the analysis when being done by computer vision. Comparison against absolute changes in color is more difficult since the lighting source, its intensity, and its angle will affect the color being read. The computer vision app would need to approximate the value being read by interpolating between its internal references.

6. Converting and Packaging, 22, 23, 24, and 25

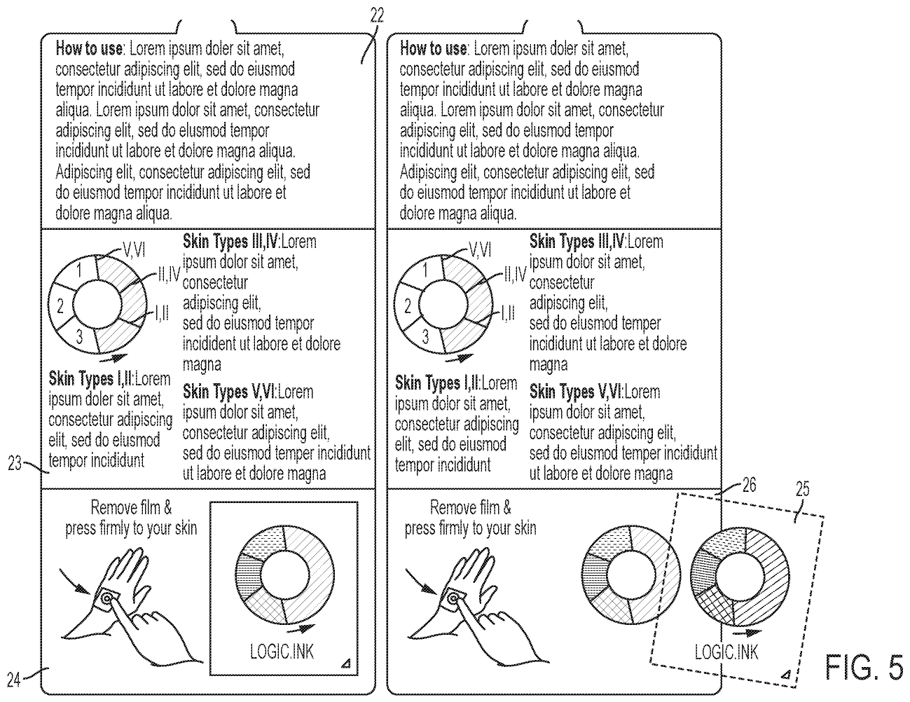

The finished devices typically will be supplied to the end user in individual UV impermeable envelopes (e.g., polycarbonate, aluminum coated paper/plastic, or thick light-opaque cardstock) to protect them from change prior to use. A non-limiting example is shown for illustration purposes in FIG. 5. In one mode, this envelope contains three sections 22-24. Section 22 provides written instructions as to how to use the device. Section 23 provides visual instructions via an infographic detailing the functionality of the instantaneous and cumulative portions of the device. Section 24 provides instruction as to how to remove the protective cover and apply the device to the skin.

Finished devices are die cut leaving appropriate margin around the artwork for substrate-to-superstrate sealing sufficient to prevent water intrusion during use. In such conversion, kiss-cuts are made such that a tab 25 is left by which the user can remove the top protective cover film, thus exposing the adhesive used to adhere the device 26 where the user pleases.

### Application of the Device, 26 and 27

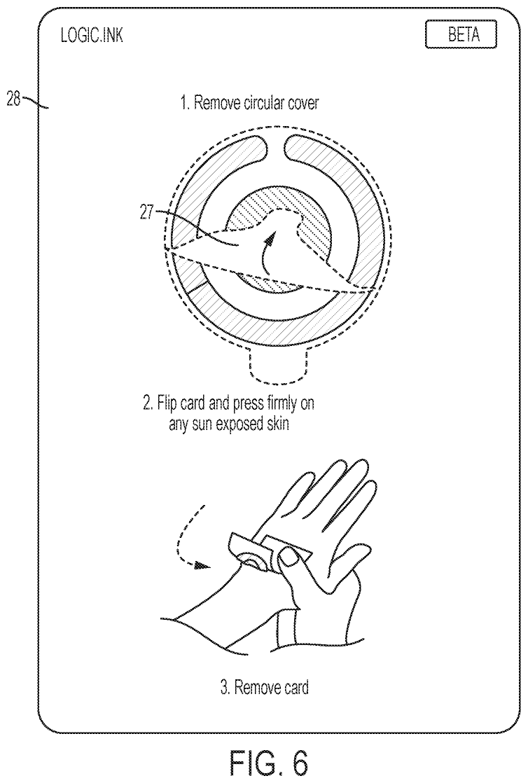

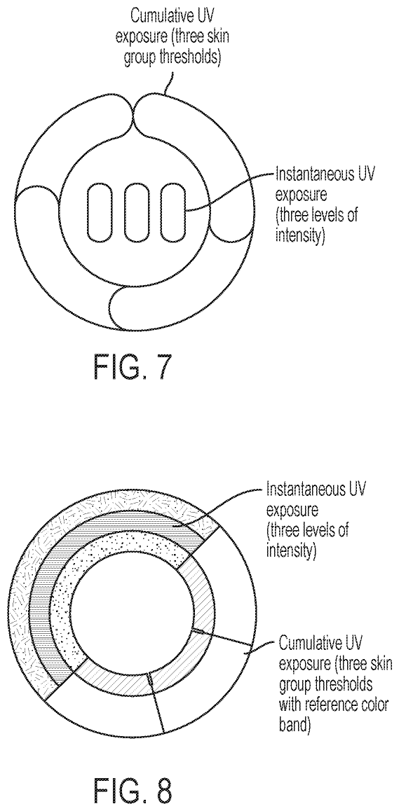

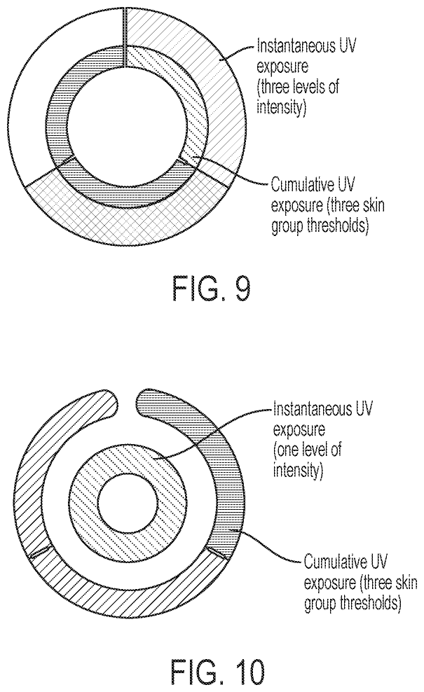

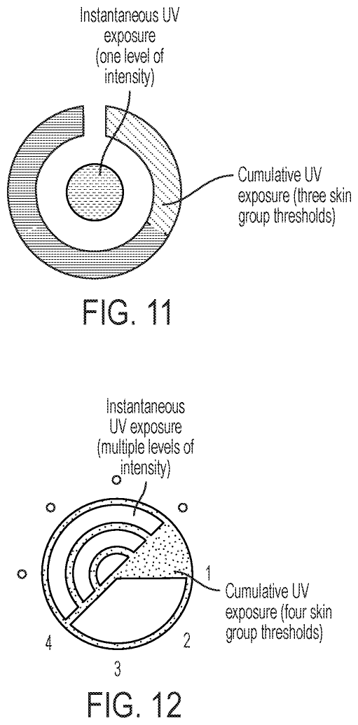

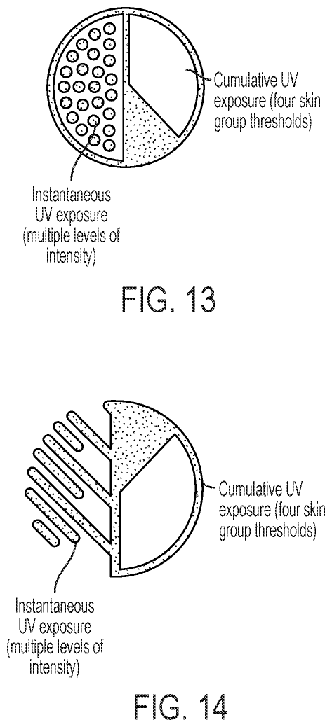

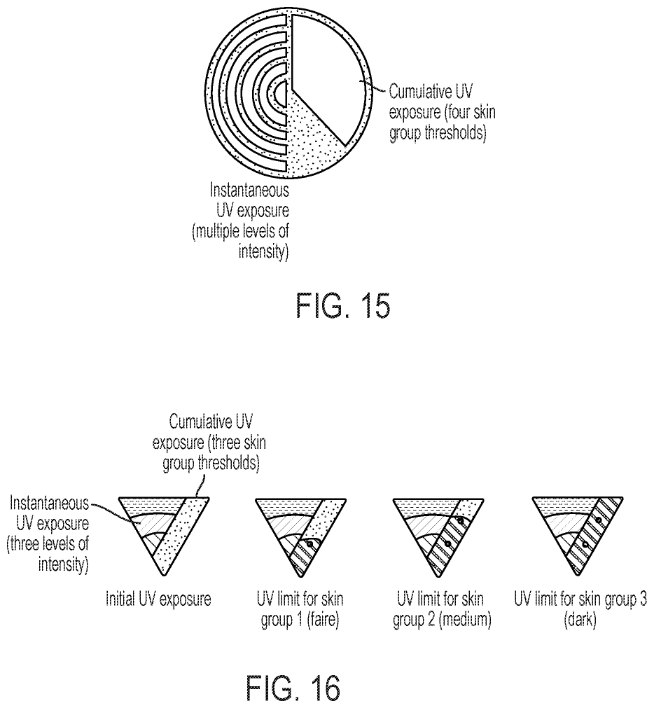

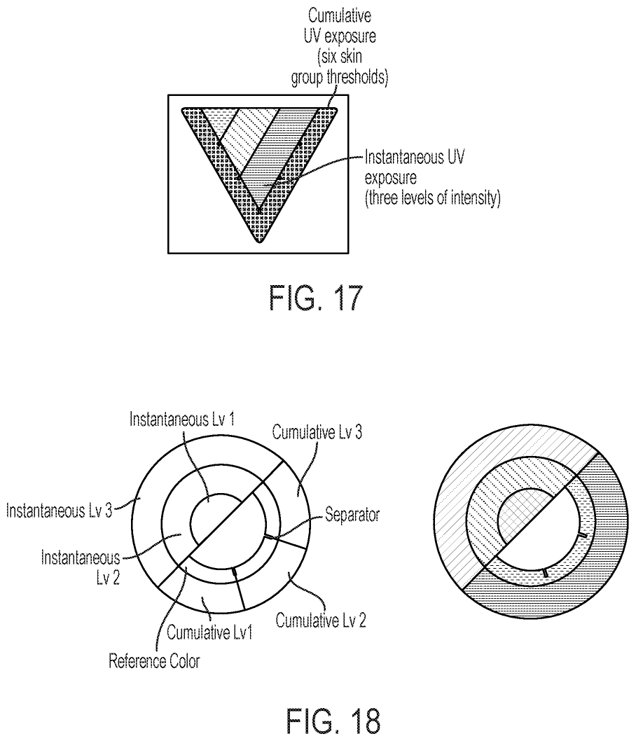

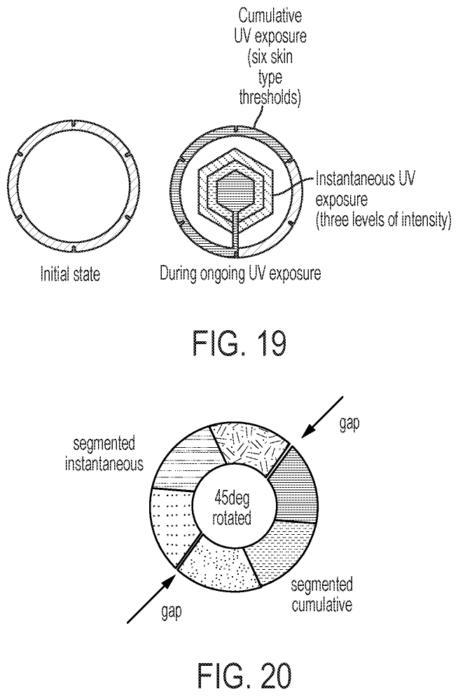

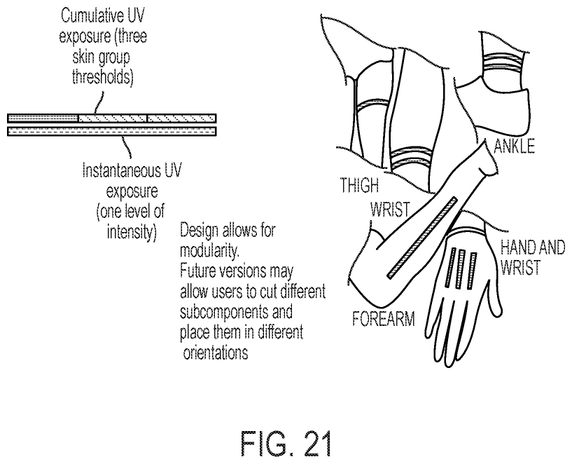

Included in the packaging are instructions for the application of the device. While the device resembles a sticker in some ways, the design, packaging, and application allow for an experience similar to that of the application of a modern temporary tattoo. A non-limiting example is shown for illustration purposes in FIG. 6. In FIG. 6, the user removes a protective cover 27 from the device. They then take the card on which the device is mounted, 28, and flip the card over to apply the adhesive side of the device to their location of choosing. Once pressure is applied, the strength of the bond of the adhesive is such that removal of the card is possible leaving behind the device on the users' location of choosing. Unlike temporary tattoos, no water or holding of the device in place for a set period of time is necessary.

### Computer Vision Reading of the Device

One approach allows the user to read information by simply comparing relative changes in color as opposed to absolute ones. Comparison against absolute changes in color is harder since the environment, type of lens used, etc, will affect the color being read. For example, if there is shade the color will look different. If the reference color is at a certain perspective that is different with respect to the color readout it will also be hard to compare. Since the reference colors do not normally cover the totality of the color changes possible, conventionally, the computer vision application would need to approximate the value being read by interpolating between two colors (this argument also applies to humans reading the tattoo with the unaided eye if reference colors were used).

The sensor device disclosed herein, using relative color changes, is much simpler even in the presence of very challenging scenarios. For example, if shade is covering a section of the tattoo, resulting in uneven solar exposure and thus creating the perception of a color change that could confuse the computer vision application, we can prevent the confusion by using two very distinct colors for the gradient. Thus, the computer vision will detect the change from blue to pink (for example) as opposed to bright blue (no shade) to dark blue (under the shade).

In alternative embodiments, reference colors can be included in the device, one each at the end of the path where the color gradient is applied. The application will compare the color change between these reference colors and the contiguous colors to determine if the product is at the beginning or end of its life. The use of reference colors can avoid the small risk that the computer vision application may not always detect the initial and end states (i.e., zero UV accumulation and full depletion of color after maximum UV accumulation).

1. A wearable UV indicator comprising a polymeric film substrate having a first side and a second side, an adhesive disposed on the first side of the substrate, and a readily understood user interface disposed on the second side of the substrate, wherein the user interface comprises a qualitative indicator of instantaneous intensity of solar ultraviolet irradiation and a qualitative indicator of accumulated exposure to solar ultraviolet radiation.

2. The wearable UV indicator of claim 1, wherein the wearable UV indicator is wearable on the skin.

3. The wearable UV indicator of claim 1 or 2, wherein the film substrate comprises a polymer selected from the group consisting of polydimethylsiloxane, thermoplastic polyurethane, thermoplastic elastomer, polyethylene, and polyethylene terephthalate.

4. The wearable UV indicator of any one of claims 1-3, wherein the qualitative indicator of instantaneous intensity of solar ultraviolet irradiation comprises a photochromic pigment suspension applied from an aqueous polymeric solution.

5. The wearable UV indicator of any one of claims 1-4, wherein the qualitative indicator of instantaneous intensity of solar ultraviolet irradiation comprises reversible UV sensitive dyes or pigments, so as to facilitate a change from one initial color to a second color.

6. The wearable UV indicator of any one of claims 1-5, wherein the qualitative indicator of instantaneous intensity of solar ultraviolet irradiation comprises trioctanoin.

7. The wearable UV indicator of any one of claims 1-6, wherein the qualitative indicator of accumulated exposure to solar ultraviolet radiation comprises a photoacid generator, and a pH dependent dye.

8. The wearable UV indicator of any one of claims 1-7, wherein the qualitative indicator of accumulated exposure to solar ultraviolet radiation further comprises a base or titania.

9. The wearable UV indicator of any one of claims 1-8, wherein the qualitative indicator of accumulated exposure to solar ultraviolet radiation further comprises an under-print of white or various colored water-based inks.

10. The wearable UV indicator of any one of claims 1-9, wherein the qualitative indicator of accumulated exposure to solar ultraviolet radiation provides a gradient of color change.

11. The wearable UV indicator of any one of claims 1-10, further comprising calibration markers to signal the UV dose received to users of different skin types.

12. The wearable UV indicator of any one of claims 1-11, further comprising fixed-tint reference colors to allow for more fine-tuned interpretation of the color change and signal provided to users.

13. The wearable UV indicator of any one of claims 1-12, further comprising a superstrate film disposed over the user interface thereby sandwiching the user interface between the substrate and superstrate.

14. The wearable UV indicator of claims 1-13, wherein the superstrate film is a polymer selected from the group consisting of polydimethylsiloxane, thermoplastic polyurethane, thermoplastic elastomer, polyethylene, and polyethylene terephthalate.

15. The wearable UV indicator of claims 1-14, wherein the superstrate film is wettable by typical sunscreens, but not permeable to active ingredients of the sunscreen.

16. A sensor system comprising a colorimetric sensor configured as two-dimensional geometry comprising a starting position and an end position, wherein the colorimetric sensor comprises a plurality of layered gradients of sensing ink components along the geometry, wherein when sensing begins, a relative change in color manifests from the starting position the change in color continues to move forward along the geometry until reaching the end position of the geometry indicative of a selected limit.

17. The sensor system of claim 16 wherein the colorimetric sensor is readable to the naked eye or via computer vision techniques.

18. The sensor system of any one of claims 16-17 wherein a computer vision application on a mobile phone can read the transformation of an absolute colorimetric readout to a relative change in color along a geometry under different lighting conditions.

19. The sensor system of any one of claims 16-18 wherein a computer vision application on a mobile phone can read the transformation of an absolute colorimetric readout to a relative change in color along a geometry with non-uniform shading.

20. The sensor system of any one of claims 16-19 wherein no reference color is included with the sensor system.

21. The sensor system of any one of claims 16-19 further comprising a reference color.

22. A method of monitoring UV exposure comprising applying the wearable UV indicator of any one of claims 1-14 to a user's skin or clothing.

23. A method of making a wearable UV indicator comprising:
applying an adhesive to a first side of a substrate;
applying a first colorimetric sensing system to a second side of the substrate; and
applying a second colorimetric sensing system to the second side of the substrate, wherein each of the first and second sensing systems is an aqueous based system, the first sensor system comprises a reversible photochromic dye that provides an indication of instantaneous UV intensity and the second sensor system comprises a photo-acid generator and a pH sensitive indicator dye that provides an indication of cumulative UV exposure.
